(19) United States
(12) Patent Application Publication
(10) Pub. No.: US 2012/0240191 A1
(43) Pub. Date: Sep. 20, 2012

(54) WIRELESS DEVICE NEARFIELD SECURITY CONFIGURATION

(76) Inventors: Jordan Husney, Minneapolis, MN (US); Mark Tekippe, Story City, IA (US)

(21) Appl. No.: 13/047,055

(22) Filed: Mar. 14, 2011

(51) Int. Cl. H04W 4/02; H04W 12/04; H04W 12/06; G06F 21/00

(52) U.S. Cl. 726/3; 370/338

(57) ABSTRACT

A joining device is operable to join a wireless network by establishing a nearfield wireless connection between the joining device and an intermediary device, and exchanging identifying information with the intermediary device that enables the joining device to securely join the wireless network.

### FIELD OF THE INVENTION

The invention relates generally to wireless networked device configuration, and more specifically in one embodiment to a system and method of wireless device nearfield security configuration.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Many of today's computers, cellular telephones, and other such devices rely on wireless networking to exchange information with other devices, such as to surf the Internet, send and receive email, and communicate audio and video. A modern cellular telephone, for example, may include a Wi-Fi interface that enables the device to join a Wi-Fi network and surf the Internet, as well as a Bluetooth interface that couples to an earpiece or car audio system for making phone calls.

Cellular telephones and other such devices have in only a couple decades gone from being obscure and expensive luxuries to replacing traditional land-line telephones. It is increasingly common for people to carry a cellular phone with them nearly wherever they go, constantly having access to not only phone functionality, but also the ability to send text messages, emails, and run a variety of applications.

Use of Bluetooth to connect a cellular phone to a headset, a car stereo system, a computer, or other such device typically involves making a device discoverable and generating a PIN, which is manually entered into the other of the two devices being joined.

Similarly, laptop or tablet computers have become a staple item for business travelers, many of whom rely on wireless networks at their destinations and along the way to communicate with the Internet. Exchanging email, surfing the web, and other such activities are often done using a secure or encrypted connection to protect the privacy of the user, again requiring that a secure link be established for the Wi-Fi connection. Much as with Bluetooth, this involves the user manually entering a shared key into the laptop, tablet, or other such device, enabling secure communication between the device and a wireless access point that shares the same key.

It is not always desirable or convenient to require that a key be displayed or presented to a user who must manually enter the key into another device to establish a secure wireless network link between a pair of devices. It requires that the key be made available to the user, such as by writing it on a sign posted near the area of use, or otherwise displaying it to the user. The user then has to copy the key, error-free, to the laptop or other device to successfully join the network.

Cell phones are also nearly as common in many parts of the world as people, and are as widely distributed and mobile as the people who carry them. The recent rise in popularity of cellular data network and other similar devices such as tablet computers and wireless cellular network cards for notebook computers has further increased the number of networked mobile devices, and the number and variety of people who use them.

Cellular phones often incorporate not only Wi-Fi, but also include Bluetooth, such as for communicating audio back and forth with an earpiece or headset, or with a car's audio system to allow hands-free communication. Linking a device to a Bluetooth accessory typically requires that a device be made discoverable, such as by pushing a button or changing a setting on the device. A PIN or personal identification number is then generated, and is manually entered on the other device of the device pair to associate the two devices. This again requires that a user manually receive the PIN from one device, and enter it as an appropriate configuration parameter in the other device to successfully join the devices.

Other network devices, such as ZigBee, DigiMesh, and other mesh network devices similarly rely on manual distribution of keys as a form of shared secret that can be used to establish a secure communication link, such as by entering the MAC address of a joining device into a “trust center” or server in the network.

In each of these examples, some manual copying of a shared secret or other identifying information must be manually entered into one of the two devices wishing to establish a secure wireless network link. It is therefore desirable to better manage key or shared secret material in secure wireless networks.

### SUMMARY

Some example embodiments of the invention comprise a joining device that is operable to join a wireless network by establishing a nearfield wireless connection between the joining device and an intermediary device, and exchanging identifying information with the intermediary device that enables the joining device to securely join the wireless network. In a further example, the nearfield communication connection comprises an ISO 14443 connection, and a first of the joining device and the intermediary device operates as a proximity coupling device and a second of the joining device and the intermediary device operates as a proximity integrated circuit card.

### BRIEF DESCRIPTION OF THE FIGURES

FIG. 1 shows an example environment comprising a joining device, and intermediate device, an authentication agent, and a wireless network access point, consistent with an example embodiment of the invention.

FIG. 2 is a flowchart showing a method of establishing a secure wireless network connection between a joining device and a wireless network access point using an intermediary device via nearfield communication coupling to the joining device, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Most wireless network technologies rely on manual distribution or sharing of a key, PIN number, or other form of a shared secret to establish a secure wireless connection between two devices in a wireless network.

For example, a Wi-Fi network typically requires that a shared key be distributed to the user of a wireless device, and that the user manually enter the key in a manner associated with the network's SSID or name. Joining a Bluetooth device to another Bluetooth device requires that one device be set as discoverable and generate a PIN number, which is then manually entered into the other device to establish communication. ZigBee networks rely on manual entry of the MAC address of a new device into a server or “trust center”, thereby establishing a shared piece of unique information that can be used to create a secure connection.

But, manual copying of PIN numbers, MAC addresses, Wi-Fi encryption keys, and other such shared secret data is prone to human error, as it is typically read and entered by hand. Some embodiments of the invention seek to address problems such as this by using a nearfield communications link with an intermediary device to send identifying information such as a MAC address, generated PIN number, key, or other such piece of shared information to a network, eliminating manual copying and keying of the shared information.

Such a system also improves on methods that might require the new device be physically coupled with the new network, such as configuration by attaching to a networked device via a USB cable or other such contact-based exchange of shared information, so that new devices can be provisioned in-field. For example, a security camera using Wi-Fi or a water sensor using mesh networking can be installed, powered up, and joined to a network using an intermediary such as a nearfield communication-enabled cell phone or PDA, where it would be difficult or impractical to bring a traditional networked computer.

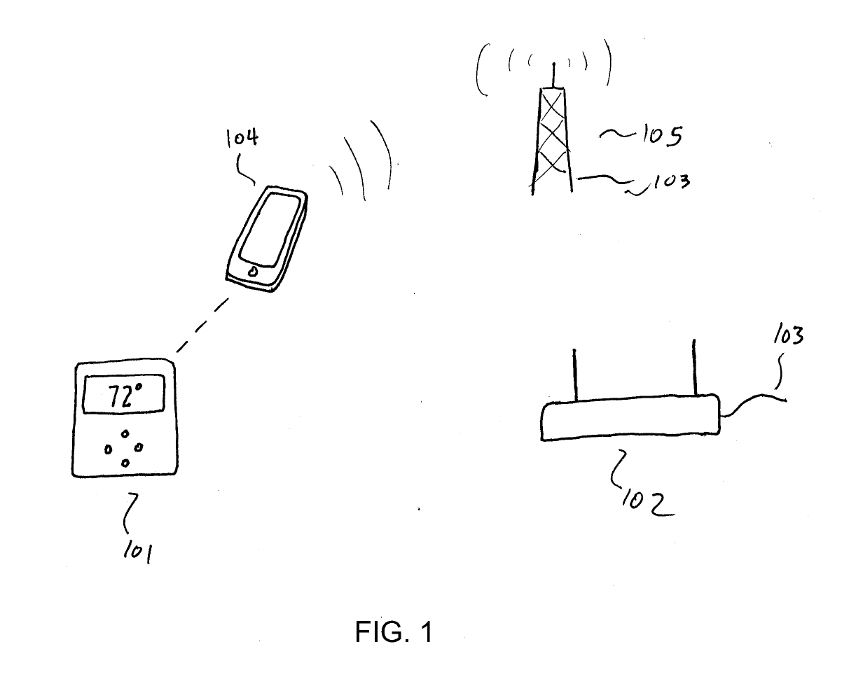

FIG. 1 illustrates an example home automation device joining a network via a nearfield intermediary device, consistent with an example embodiment of the invention. Here, a thermostat device 101 is installed and powered on, and is desired to join a wireless network provided by wireless network access point 102. In a further embodiment, the wireless network is a Wi-Fi network, and is connected to the Internet via network connection 103.

To join the network, thermostat device 101 communicates with an intermediary device, such as cellular telephone 104, using nearfield communication. The intermediary device is further coupled to the Internet or another suitable network, such as by communication with cell phone tower 105 in this example

In operation, the thermostat device 101 sees the intermediary device 104 when they are positioned near enough to one another to enable nearfield communication. Once the nearfield connection is established, the thermostat device 101 exchanges data with an authentication agent on the network, such as a server. The server exchanges data with the wireless network access point 102, enabling the thermostat 101 to join the wireless network.

Information exchanged between the thermostat device and the authentication agent in one example comprises simple identity information, such as a MAC address, a PIN number, or another piece of information that can later be used to establish a secure direct connection between the thermostat device 101 and the wireless network access point 102.

In another example, the information exchanged between the thermostat device 101 and the authentication agent is a two-way data exchange, and the thermostat 101 provides some identifying information such as a MAC address and the authentication agent provides a set of credentials such as a Wi-Fi key and network configuration parameters in response. This enables the device 101 to join the network without the network access point 102 communicating encryption keys, network configuration data, and other such information to the thermostat 101 to set up a secure wireless connection.

The nearfield communication link between the thermostat 101 and the cellular telephone 104 in the example of FIG. 1 is in some embodiments established via an installable nearfield communication module attached to the thermostat 101, such that it can be removed and installed on other devices to perform configuration once the thermostat 101 is configured. In other embodiments, a nearfield communication module is integrated or built into devices to facilitate easy configuration.

Nearfield communication includes in a more detailed example communication using the ISO 14443 standard for contactless proximity identification cards. In this example, a low-frequency (13.56 MHz) signal is used to establish communication between a proximity coupling device or reader device, such as the cellular phone 104 of FIG. 1, and a proximity integrated circuit card, or connected device 101. The ISO standard provides for data communication in both directions, enabling not only sending information such as a MAC address or key from the thermostat 101 to the cellular phone device 104, but also sending data such as Wi-Fi keys and other network configuration information from the cellular phone device 104 to the thermostat 101. In other embodiments, other suitable nearfield wireless communications are used to exchange data between a device such as thermostat 101 and an intermediary such as cellular phone 104.

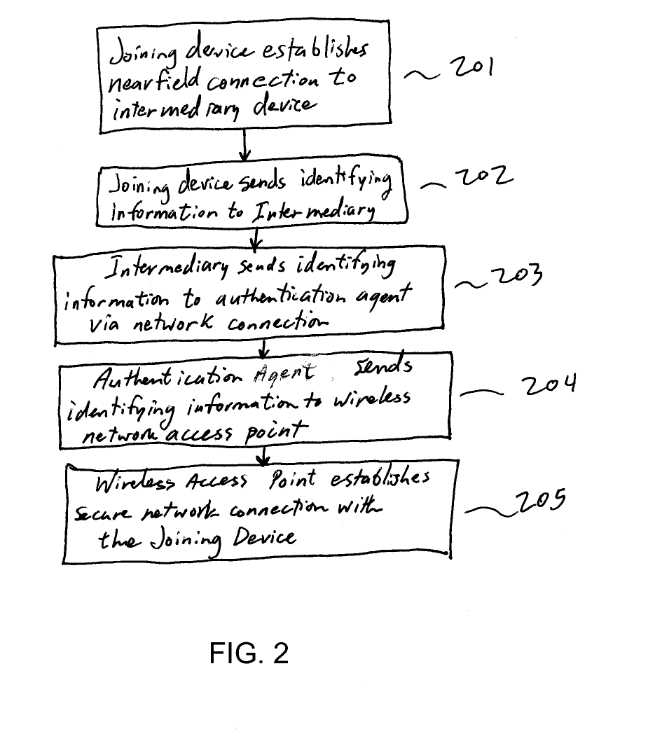

FIG. 2 is a flowchart illustrating using a nearfield-coupled intermediary device to facilitate joining a device to a wireless network, consistent with an example embodiment of the invention. At 201, a joining device such as 101 of FIG. 1 establishes a nearfield connection to an intermediary device such as cellular telephone 104. The joining device sends identifying information to the intermediary device at 202, such as a MAC address or other unique identifier, or a shared secret such as a PIN number or key.

The intermediary sends the identifying information received from the joining device to an authentication agent, such as a network server, at 203. The authentication agent receives the identifying information, and is aware of the network the joining device is attempting to join. The network identifying information is in some embodiments sent by the intermediary device, such as a user employing an application that receives and forwards network identifying information to the authentication agent. In other embodiments, the location of the joining device or the intermediary device, characteristics of the joining device, data stored in the authentication agent, or other such information is used to determine the network the joining device is attempting to join.

The authentication agent sends the identifying information to the appropriate wireless network access point such as 102 of FIG. 1 at 204. The wireless access point is then able to use the identifying information to establish a secure link between the access point and the joining device, facilitating a relatively easy secure connection between the joining device and the wireless network.

In a more detailed example, information is sent from the wireless access point or from the authentication agent back to the joining device in establishing the secure connection. In one such example, the wireless access point returns network information such as a wireless network encryption key or other information back to the joining device via the intermediary device to facilitate establishing a secure connection between the joining device and the wireless network access point. In another example, the authentication agent has a record of keys or other such information needed to join a specific wireless network, and sends this information back to the joining device via the intermediary device. In still a further example, the intermediary device is operable to store or cache information such as wireless network encryption keys in the device itself, returning the information needed to establish a secure link between the joining device and the wireless network access point to the joining device upon establishing a nearfield communications link.

These examples illustrate how a nearfield communication link to a portable intermediary device such a cell phone can be used to establish a secure communication link between a wireless network access point and the joining device, without requiring that encryption keys or other such information be manually copied and entered into one of the devices. Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A method of joining a joining mesh network device to a wireless mesh network, comprising:
establishing a nearfield wireless connection between the joining mesh network device and an intermediary device; and
exchanging identifying information with the intermediary device that enables the joining device to securely join the wireless mesh network.

2. The method of joining a joining mesh network device to a wireless mesh network of claim 1, further comprising exchanging the identifying information between the intermediary device and an authentication agent.

3. The method of joining a joining mesh network device to a wireless network of claim 2, further comprising exchanging the identifying information between the authentication agent and a wireless network access point.

4. The method of joining a joining mesh network device to a wireless mesh network of claim 1, wherein the identifying information comprises a shared secret or encryption key sent from the intermediary device to the joining mesh network device to enable the mesh network device to securely join the wireless mesh network.

5. The method of joining a joining mesh network device to a wireless mesh network of claim 1, wherein the nearfield wireless connection comprises an ISO 14443 or proximity card connection.

6. The method of joining a joining mesh network device to a wireless mesh network of claim 5, wherein a first of the joining mesh network device and the intermediary device operates as a proximity coupling device and a second of the joining mesh network device and the intermediary device operates as a proximity integrated circuit card.

7. A wireless mesh network device, comprising:
a nearfield wireless communication module operable to establish a nearfield wireless connection between the mesh network device and an intermediary device, and to exchange identifying information with the intermediary device that enables the mesh network device to securely join a wireless mesh network.

8. The wireless mesh network device of claim 7, wherein the identifying information is further exchanged between the intermediary device and an authentication agent.

9. The wireless mesh network device of claim 8, wherein the identifying information is further exchanged between the authentication agent and a wireless mesh network access point.

10. The wireless mesh network device of claim 7, wherein the identifying information comprises a shared secret or encryption key sent from the intermediary device to the mesh network device to enable the mesh network device to securely join the wireless mesh network.

11. The wireless mesh network device of claim 7, wherein the nearfield wireless connection comprises an ISO 14443 or proximity card connection.

12. The wireless mesh network device of claim 11, wherein a first of the mesh network device and the intermediary device operates as a proximity coupling device and a second of the mesh network device and the intermediary device operates as a proximity integrated circuit card.

13. A wireless network intermediary device, comprising:
a nearfield communication module operable to establish a nearfield wireless connection between a joining mesh network device and the intermediary device, and to exchange identifying information with the joining device that enables the joining mesh network device to securely join a wireless mesh network.

14. The wireless network intermediary device of claim 1, further comprising a network connection operable to exchange the identifying information between the intermediary device and an authentication agent.

15. The wireless network intermediary device of claim 14, wherein the identifying information is further exchanged between the authentication agent and a wireless mesh network access point.

16. The wireless network intermediary device of claim 13, wherein the identifying information comprises a shared secret or encryption key sent from the intermediary device to the joining device to enable the device to securely join the wireless mesh network.

17. The wireless network intermediary device of claim 13, wherein the nearfield wireless connection comprises an ISO 14443 or proximity card connection.

18. The wireless network intermediary device of claim 17, wherein a first of the joining mesh network device and the intermediary device operates as a proximity coupling device and a second of the joining mesh network device and the intermediary device operates as a proximity integrated circuit card.
